(19) United States
(12) Patent Application Publication
(10) Pub. No.: US 2013/0206268 A1
(43) Pub. Date: Aug. 15, 2013

(54) CONNECTING DEVICE FOR THE FLUIDIC CONTACTING OF MICROFLUIDIC CHIPS

(71) Applicant: Frank K Gehring, Obernheim (DE)

(72) Inventor: Frank K Gehring, Obernheim (DE)

(73) Assignee: ANDREAS HETTICH GMBH & CO. KG, TUTTLINGEN (DE)

(21) Appl. No.: 13/821,398

(22) PCT Filed: Sep. 14, 2011
(86) PCT No.: PCT/EP11/65946

§ 371 Date: Apr. 13, 2013

(30) Foreign Application Priority Data
Sep. 14, 2010 (DE) 10 2010 037 532.2

(51) Int. Cl. F16L 11/00

(52) U.S. Cl. CPC F16L 11/00
USPC 138/109

(57) ABSTRACT

The invention relates to a connecting device for the fluidic contacting of a microfluidic chip (12), wherein openings are introduced in the surface of the microfluidic chip (12) and the connecting device comprises a carrier plate (14) and at least one connector (16). The invention is characterized in that the connector (16) comprises a sleeve 22 and a flange (26) arranged coaxially with respect to the sleeve 22 and the inside diameter of the sleeve 22 is dimensioned such that it receives a microfluidic hose (30) and the outside diameter is dimensioned such that the sleeve 22 can be received in a cut-out introduced in the carrier plate (14).

The invention relates to a connecting device for the fluidic contacting of microfluidic chips according to the preamble of claim 1.

In accordance with the prior art disclosed in “A fast and reliable way to establish fluidic connections to planar microchips”, it has been known to use an elastic sleeve on a macrofluidic line for extending the latter for the purpose of contacting microfluidic platforms. The outside diameter of this macrofluidic line roughly corresponds to the inside diameter of said sleeve. The macrofluidic line is inserted in a contact body having a cut-out which has the outside diameter of the sleeve. Furthermore, the elastic sleeve has been dimensioned such that it axially extends beyond the outside diameter of the contact body. When a microfluidic platform is aligned with and placed upon a respective through-hole in said contact body, said elastic sleeve will be compressed in its seat within said contact body, thus sealing the microfluidic chip from said contact body. On its side facing away from the microfluidic chip, the contact body exhibits bores for the insertion of macrofluidic lines whose inside diameters correspond to that of the sleeve. In a non-contact state, this will thus allow a macrofluidic line to be inserted in the elastic sleeve. The compression of the elastic sleeve during contacting will result in a change of the cross-section of its inside diameter, thus causing the transition between the macrofluidic line and the sleeve to be sealed. This embodiment is disadvantageous in that the contact area is very small and the sealing surface is susceptible to contamination. Moreover, it does not allow for compensation of any inaccurate positioning of the microfluidic chip.

It is the object of the present invention to provide a connecting device for contacting microfluidic chips which ensures a high degree of leak tightness and can be connected to, or disconnected from, the microfluidic chip in a fast and simple manner.

This object is accomplished by the features of claim 1.

The subclaims relate to advantageous further developments of the invention.

In accordance with the invention, the connecting device includes at least one connector which comprises a sleeve which has an annular flange at its end. Said annular flange is arranged between the facing surfaces of the carrier plate and the microfluidic chip to be contacted, respectively.

This annular flange on the sleeve improves the sealing characteristics. Contrary to the prior art, in which only a small contact area, i.e. the annular area between the inside and the outside diameter, is sealed, the sealing surface here is clearly increased by the integrally moulded annular flange. Moreover, the power flow changes in such a way that the cross-section or inside diameter of the sleeve structure accommodated in the contact body will not be constricted. This ensures reproducible flow characteristics with improved sealing.

Integrally moulding a flange seal on an elastic sleeve has the advantage that an equivalent seal can be obtained using a lower pressing force. In case there are several connectors for a fluidic chip, a more or less damping layer is obtained between the fluid connecting plate and the microfluidic chip. This avoids tensioning of the fluidic chip and guarantees its proper functioning.

In addition, the annular flange has a compensating function which allows minor unevenness and/or tolerances in the production of the fluidic chip to be compensated.

In a particularly advantageous embodiment of the invention, the sleeve and the annular flange are made as one piece. This has the advantage of an optimum power flow. Moreover, this avoids the formation of a small gap through which dirt particles might enter. Furthermore, handling is clearly improved by one-piece connection elements. In yet another advantageous embodiment, the annular flanges are directly glued or injection-moulded onto the carrier surface. This improves handling when the carrier plate is connected to the microfluidic chip as well as during cleaning.

The invention allows a microfluidic chip to be releasably contacted in a very fast and yet reliable manner. Centering may preferably be performed by means of the connection plate. This type of connection allows several connection points of a fluidic chip to be contacted at the same time. This constitutes an enormous saving of time compared to conventional screwed connections which all have to be screwed into the respective supports individually.

In yet another preferred embodiment of the invention, the sealing connections are made of PDMS or other resistant and elastic plastic connectors. In yet another preferred embodiment, the opening in the flange is somewhat smaller in diameter than the sleeve and somewhat larger in diameter than the microfluidic connection opening to be contacted. Preferably, the opening cross-section in the flange corresponds to the inside diameter of the hose. This results in a particularly small dead volume.

The plastic connectors are preferably already provided in the carrier plate or—according to an alternative embodiment—may be subsequently inserted in the carrier plate.

In yet another advantageous embodiment, the cross-section of the opening in the carrier plate for accommodating the sleeve has been chosen slightly smaller than the outside diameter of the plastic sleeve. This causes the sleeve to be compressed in a radial direction which clearly improves the leak tightness with respect to the hose.

Advantageously, the annular flange may be designed such that the inside diameter of the annular flange will correspond to that of the line. In particular, the annular surface of the line will then abut on the flange.

Further advantages, features and possible applications of the present invention will become apparent from the following description in which reference is made to the embodiments illustrated in the drawings.

Throughout the description, the claims and the drawings, those terms and associated reference numerals are used as are listed in the list of reference numerals which follows below. In the drawings,

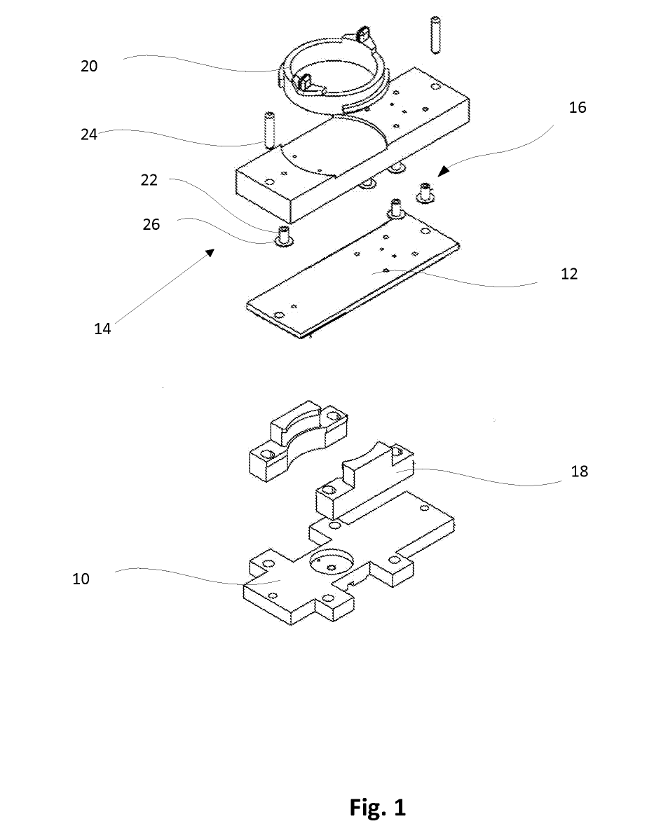

FIG. 1 is an exploded view of a microfluidic system comprising the connecting device of the invention;

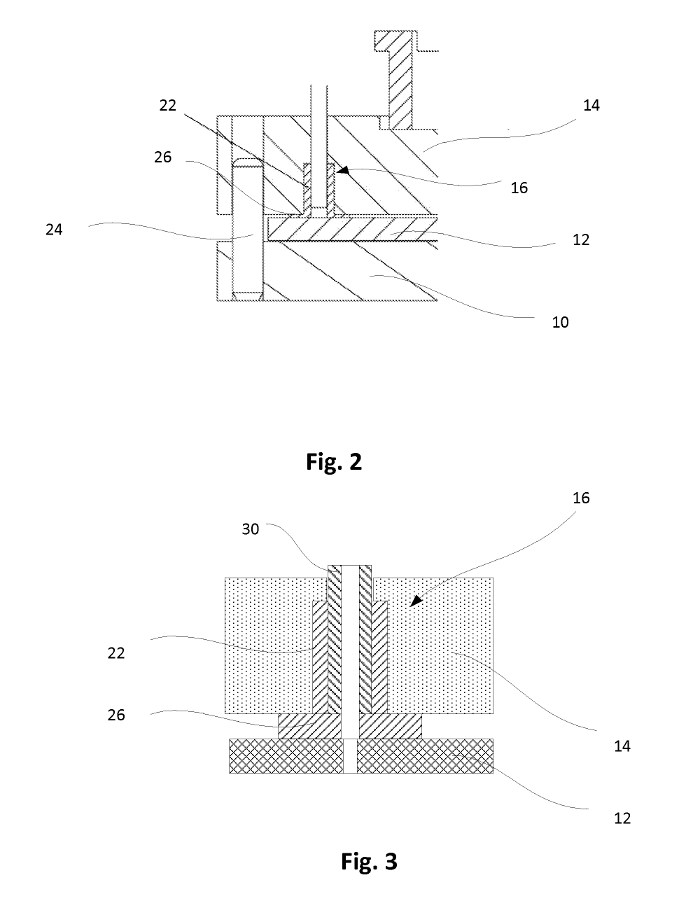

FIG. 2 is a sectional view of the components of the microfluidic system; and

FIG. 3 is a detailed sectional view of the connecting device.

FIG. 1 is an exploded view of a microfluidic system comprising a bottom plate, a microfluidic chip, a connecting plate with inserted connectors as well as holding means 18 for accommodating a quick-release fastener 20 therein. The holding means 18 are installed on the bottom plate 10. The microfluidic chip 12 will be inserted between the holding means 18. The side of the carrier plate 14 facing the microchip includes openings for insertion of the connectors 16. The side facing away from the microchip has openings in which a macrofluidic line or a hose can be inserted. More precisely, the macrofluidic hose is inserted in the sleeve 24 of a connector. Furthermore, centering pins 22 are provided which extend through the bottom plate, the microfluidic chip and the carrier plate in order to ensure that the connection openings of the microfluidic chip and those of the connectors 16 are aligned so as to lie flush on top of each other. The quick-release fastener ring 20, which—in the assembled state—engages the holding means 18, presses the carrier plate 14 onto the microfluidic chip. As a result, all connectors simultaneously tightly connect the macrofluidic hose with the microfluidic chip.

This allows different microfluidic chips to be contacted in a simple way. This is especially true when all microfluidic chips have their openings for access to the microfluidic system at the same positions within the chip. This allows different chips to be installed in and/or removed from a respective device in a fast and easy manner. The connections feature a high degree of flexibility, a high sealing capacity and a low dead volume.

FIG. 2 is a sectional view which also shows the hose inserted in a connector. This view shows the bottom plate 10, the microfluidic chip 12, the carrier plate 14, a centering pin 22 and a connector 16 provided in the carrier unit. In the state illustrated in FIG. 2, the carrier is mechanically fastened to the bottom plate. This results in a compression of the annular flange 26 formed on the sleeve 24 in the area in which said annular flange 26 lies between the carrier plate 14 and the microfluidic chip 12. The opening of the microfluidic chip 12 is aligned with and/or coaxial to the respective connector 16.

FIG. 3 is a detailed sectional view of a connector 16 in a carrier plate 14, with the connector 16 positioned on a microfluidic chip 12. The connector 16 comprises a sleeve 24 and an annular flange 26 formed on the latter. Inserted in said sleeve is the end of a macrofluidic hose 30. In this embodiment, the inside diameter of the opening within the flange is dimensioned such that it corresponds to the inside diameter of the hose. This ensures that there will be no dead volume between the hose 30 and the sleeve 24 provided that the hose 30 has been pushed up to the annular flange 26. Moreover, the inside diameter of the annular flange 26 is dimensioned to be somewhat larger than the opening of the fluidic chip. This allows tolerances to be compensated in the connection and reliable contacting to be ensured despite inaccuracies.

### LIST OF REFERENCE SIGNS

10 bottom plate
12 chip
14 carrier plate
16 connector
18 holding means
20 quick-release fastener
22 adjustment pin
24 sleeve
26 annular flange
30 hose

1-7. (canceled)

8. Connecting device for the fluidic contacting of a microfluidic chip (12), comprising:
said microfluidic chip (12) has a surface;
said surface of said microfluidic chip (12) includes openings therein;
a carrier plate (14);
at least one connector (16);
said connector (16) comprises a sleeve (22) and a flange (26), said sleeve includes an axis, said flange includes an axis, said axis of said sleeve and said axis of said flange are coaxial;
said sleeve (22) includes an inside diameter and an inner surface;
said sleeve (22) includes an outside diameter and an outer surface;
a macrofluidic hose (30);
said inside surface of said sleeve (22) engages said macrofluidic hose (30); and,
said outer surface of said sleeve (22) engages a cut-out in said carrier plate (14).

9. Connecting device for the fluidic contacting of a microfluidic chip (12) as claimed in claim 8, wherein said sleeve (22) and said flange (26) of said connector (16) are one piece.

10. Connecting device for the fluidic contacting of a microfluidic chip (12) as claimed in claim 8, further comprising:
said carrier includes a first side facing said microfluidic chip (12); and,
said flange (26) is inserted in said carrier (14), said flange engages, flushly, said first side of said carrier facing said microfluidic chip (12).

11. Connecting device for the fluidic contacting of a microfluidic chip (12) as claimed in claim 8, said outer surface of said sleeve engages said carrier plate (14).

12. Connecting device for the fluidic contacting of a microfluidic chip (12) as claimed in claim 8, wherein said flange (26) and said carrier plate (14) are firmly engaged and connected.

13. A connector (16) comprising a sleeve (22) and an annular flange (26), said connector usable in a connecting device, said connecting device includes a carrier, and a microfluidic chip.

14. The connector (16) of claim 13, further comprising:
said sleeve (22) includes an inside diameter and an inner surface;
said sleeve (22) includes an outside diameter and an outer surface; and,
said inside diameter of said annular flange (26) corresponds to said outside diameter of a macrofluidic line (30) to be inserted therein.
